(19) United States
(12) Patent Application Publication
(10) Pub. No.: US 2012/0082972 A1
(43) Pub. Date: Apr. 5, 2012

(54) MODULAR ROBOTICS DESIGN AND DEVELOPMENT SYSTEM WITH VARYING LEVELS OF COMPLEXITY

(75) Inventor: Bryan A. Theriault, Grand Rapids, MI (US)

(73) Assignee: Bryan A. Theriault, Grand Rapids, MI (US)

(21) Appl. No.: 13/250,206

(22) Filed: Sep. 30, 2011

Related U.S. Application Data
(60) Provisional application No. 61/404,243, filed on Sep. 30, 2010.

(51) Int. Cl. G09B 23/00

(52) U.S. Cl. 434/276

(57) ABSTRACT

A modular educational robotics design and experimentation system is disclosed herein. The disclosed system includes a chassis onto which a plurality of components can be mounted. Components can be logical components, sensors, output components such as motors, or other kinds of components. In various embodiments, components can be electrically connected to one another by wires that may have varying diameters and connection technologies depending on the contemplated age of the users of the system. The wires may also include a feature to indicate when they are connected in an allowable fashion. In addition, components may be mechanically connected to one another using proprietary connector technology in which uprights having stems with a particular shape can be tightened to the chassis using thumbscrews. The disclosed system advantageously enables students of varying ages to experiment with robotics concepts using modules optimized for certain tasks and ages of users.

### PRIORITY CLAIM

This application is a non-provisional application of, claims priority to and the benefit of U.S. Provisional Patent Application No. 61/404,243, filed Sep. 30, 2010, the entire contents of which are incorporated herein by reference.

### FIELD OF THE DISCLOSURE

The present disclosure is directed to modular robotics exploration systems. Specifically, the present disclosure is directed to a system in which a plurality of components, which vary in complexity depending on the user, can be connected to a common chassis to enable students to explore concepts in the field of robotics.

### BACKGROUND

The study of robotics involves many diverse disciplines, including computer programming, electronics design, and mechanical design. For example, a simple robotics project in which a sensor detects the presence of a wall and turns a motor-driven, wheeled robot away from the wall may require an implementer to physically connect mechanical components, such as wheels, to a robot body, to electronically connect one or more motors and one or more proximity sensors to a controller, and to program the controller to interpret the output of the sensors and to operate the motors accordingly to turn the robot away from the sensed wall.

Moreover, many robotics components (such as motors, sensors, and controllers) are not designed for a particular robotics application. Thus, particular motors may not be designed to easily interface with particular controllers, and particular sensors may not provide data easily convertible into signals to drive motors. In addition, the mechanical connection mechanisms may not enable ready connection of components purchased off-the-shelf, so people wishing to join components may need to be facile in soldering or other difficult mechanical connection techniques.

Finally, many robotics components are not designed with a particular programming environment or language in mind. Thus, while one sensor may be optimized for use in a first programming environment, another sensor or a motor may be optimized for use in a second, different programming environment. Thus, in addition to the electrical and mechanical concerns described above, conventional robotics design environments may require a student to program components, not otherwise designed to operate in the same environment, to operate in the same environment. This requirement may add to the complexity, and thus feasibility, for a student to learn and design robotics projects.

As a result of these complexities, the study of robotics is frequently daunting for the uninitiated, and people wishing to learn its fundamentals may not know where to start. In addition, because of the required mastery in conventional systems of a number of different disciplines, it is often impractical to try to teach individuals the fundamentals of robotics at a young age. Instead, the fundamentals cannot begun to be taught until individuals have a sufficient grasp of the basic concepts and skills, which may not occur until the individual is in high school, college, or later. Finally, because of the lack of guaranteed interoperability of components, individuals wishing to explore robotics technology may not be able to reference a single, authoritative source of documentation to teach concepts and aid in troubleshooting.

### SUMMARY

A modular educational robotics system that enables individuals of all ages to study concepts and principles associated with robotics is disclosed herein. The disclosed robotics system enables students of all grade levels, such as kindergarten-aged children through undergraduate collegiate students, to study robotics concepts using a system that relies on a single chassis and one or more interoperable expansion modules connectable using universal electrical and mechanical connectors. The disclosed modular robotics system enables students and other individuals to learn, study, and explore concepts associated with electronics, prototyping, and engineering.

In one embodiment, the modular robotic system disclosed herein maximizes usability and applicability by relying on a standard chassis on which future projects at all skill levels can be built. For example, the standard chassis of the disclosed system may include one or more small solder-less breadboards and one or more spacers to enable the chassis to act as a common base for electromechanical robotics projects. In various embodiments, the chassis also includes one or more proprietary physical connectors to enable component modules, sensor modules, and other modules to be physically attached to the chassis.

In one embodiment, various modules and/or components can be electrically connected to one of the breadboards of the chassis to enable those modules or components to be easily incorporated in desired projects. For example, the breadboard may include one or more receptacles to enable one or more wires to be connected to the breadboard and to one or more components. In various embodiments, the breadboards associated with or connected to the chassis are not designed for a particular function, but rather enable students to incorporate one or more components with the disclosed robotics system, which components have one or more particular or pre-built functionalities.

In one embodiment, in addition to including one or more breadboards that enable the electrical connection of components to the chassis, the chassis of the disclosed robotics system includes one or more mechanical connection points to enable mechanical connection of components to the chassis. In an embodiment, one or more proprietary connectors, discussed in more detail below, enable the connection of both electrical components (e.g., controller or sensor components) and mechanical or mobility components (e.g., motors, wheels, treads, or the like) to the chassis depending on the desires of the user of the disclosed robotics system.

The disclosed robotics system relies on a chassis and components having one or more varying functional capabilities to enable the implementation of robotics projects having desired functionality. In one embodiment, the robotic system disclosed herein includes a plurality of modularly designed components. These components may include a chassis, a plurality of component modules, and a plurality of sensors. In other embodiments, the disclosed robotics system includes one or more output components provide outputs, such as by driving motors or illuminating display devices, to indicate the operation of the remaining components.

In an embodiment, one or more of the components, which is electronically connectable to the chassis, has a particular or specialized functionality. For example, a standard power and motor control module may be built from a voltage regulator component and a quad H-bridge integrated circuit on one breadboard, which can be wired with several different swappable sensor and signal control schemes built onto other breadboards. Controllers having other functionalities, such as controllers for interpreting conditions sensed by various sensor and/or sensor components themselves, and/or controllers for driving one or more output devices such as motors, are also contemplated and are discussed in further detail below.

In an embodiment, the sensor and component modules usable with the disclosed robotics system vary according to the age and/or experience of the designed users of those modules. For example, a sensor module may be optimized for use by students of a designated grade to reduce cost while providing functionality typically within the grasp of the students. In this way, components from previously obtained modules can be incorporated into new designs as students' experience and skill improves.

In one embodiment, the disclosed robotics system includes one or more features to enable easy electrical connection of components to the disclosed chassis. These features may be designed according to the contemplated age, dexterity, and/or skill level of the expected user. For example, in an implementation of the disclosed robotics system designed for relatively young individuals, who may lack the dexterity to connect bare wires with a breadboard, sockets in the breadboard may be larger, wires may be of a larger gauge, and/or wires may include one or more easily-graspable end pieces or sheaths.

In addition, the robotics system disclosed herein may include one or more features that readily indicate to a user whether an electrical connection made by the user is allowable or not. For example, in an implementation of the disclosed robotics system designed for children aged from kindergarten through third grade, one or more breadboards of the disclosed chassis includes wider contact holes. In this embodiment, one or more jumpers is also provided, which jumpers are relatively thick prefabricated cables with end pieces designed for easy plug-in and removal. In this embodiment, the components connectable to the disclosed chassis may include one or more electrical features that readily indicate whether a connection is allowable. For example, the components may be electronically keyed, such that when a correct or allowable connection is made, a green light emanates from both ends of the jumper, while a red light shows on each end in the case of an incorrect or non-allowable connection.

The system disclosed herein thus provides a flexible, chassis-based robotic experimentation and development system that is adaptable for use by users of different ages and skills. In various embodiments, the functionality built into the components connectable to the chassis varies, such that the user is required to implement more or less of the functionality himself or herself, depending on the user's facility with robotics. One or more proprietary electrical and/or mechanical connectors enable the mechanical and electrical connections, respectively of components to the chassis and/or to one another.

It is thus an object of the instant disclosure to provide a system that obscures various complexities of the concepts surrounding robotics development depending on the age, dexterity, and skill level of the user of the system. It is a further object of the instant disclosure to provide a system in which a common chassis is usable with a series of components and sensors whose capabilities and complexities grow with the user. Further, it is an advantage of the disclosed system to provide proprietary connectors to enable components to be easily interchanged and connected to a chassis depending on the capabilities of a user and on the desired functionalities of the robotics project. Finally, a robotics system is needed which enables the creation of standard documentation applicable to a number of different components and capabilities, such that individuals can effectively explore robotics concepts without explicit instructor interaction.

### BRIEF DESCRIPTION OF THE FIGURES

FIG. 1 is a schematic representation of an example chassis usable with the robotics system disclosed herein;

FIG. 2 is a perspective view of a schematic diagram of one embodiment of a breadboard usable with the robotics system disclosed herein;

FIG. 3 is a circuit diagram of one embodiment of the pulse-width modulator component of the line-following implementation disclosed herein;

FIG. 4 illustrates a plurality of tables, including a truth table and two Karnaugh maps, identifying the functionality underlying the combinatorial logic line follower embodiment of the disclosed robotics system;

FIG. 5 illustrates a simplified block diagram of the modules of the exemplary combinatorial line-following implementation of the disclosed robotics system;

FIG. 6 illustrates a block diagram of the components of the disclosed combinatorial line-following implementation of the disclosed robotics system;

FIG. 7 is a schematic illustration of an example of the proprietary connectors used to connect components of the disclosed system to each other and to the disclosed chassis;

FIGS. 8a and 8b are schematic diagrams of the embodiment of the proprietary connectors illustrated in FIG. 7 as used to support a breadboard on the chassis disclosed herein;

FIG. 9 is a schematic illustration of a different example of the proprietary connectors used to connect components of the disclosed system to each other and to the disclosed chassis; and

FIGS. 10a, 10b, and 10c are illustrations of one example embodiment of the disclosed robotics system in which a plurality of the uprights illustrated in FIG. 9 are used to support a plurality of tiers of breadboards on a chassis having two wheels and a roller mounted thereto.

### DETAILED DESCRIPTION

The system disclosed herein is a modular robotics design and experimentation system that provides users with components whose complexity grows as the user's facility grows. The disclosed robotics system in one embodiment includes a standard chassis with one or more breadboards mounted thereto. In this embodiment, the chassis also includes one or more mounting points to mount components, such as wheels, motors, controllers, and/or other electronics components, to the chassis. This arrangement enables a user to study concepts associated with robotics by connecting components of varying functionalities to the chassis, and by electrically connecting those components to the breadboard mounted on the chassis. The robotics system thus enables the user to create robots having varying functionalities and enables the users to experiment with components of varying complexities, while relying on a common chassis.

Since children at lower grade levels may not have the dexterity to work with standard breadboards nor the experience to properly wire the components on the first attempt, specialized breadboards, jumper wires and components may be used in various embodiments to counteract these deficiencies. For example, breadboards used in the Kindergarten through third grade age range may have wider contact holes and the jumpers provided may be thicker prefabricated cables with end pieces designed for easy plug-in and removal. In various embodiments, the components used at these relatively younger levels may also be electronically keyed, such that when a correct connection is made, a green light emanates from one or both ends of the jumper, while a red light shows on each end in the case of an incorrect connection.

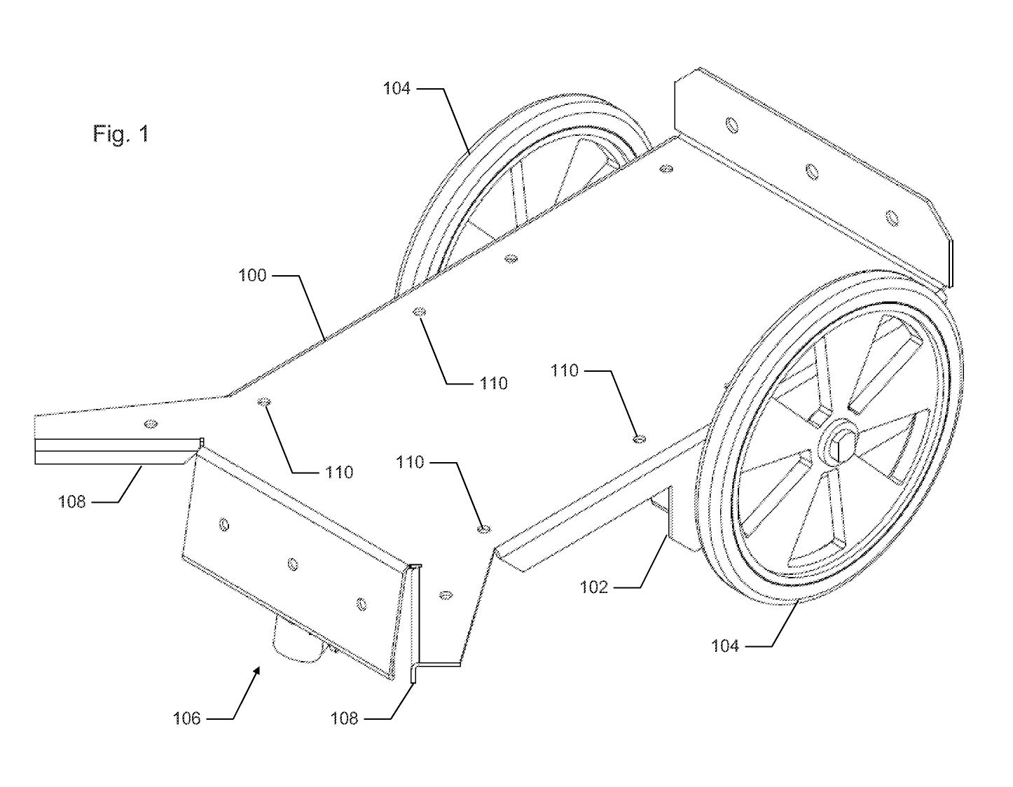

FIG. 1 is a perspective view of a schematic illustration of one embodiment of the chassis disclosed herein. As illustrated in FIG. 1, chassis 100 is a folded-metal object having a shape appropriate for the robotics system disclosed herein. In the illustrated embodiment, one or more portions of the chassis 102 are adapted to have wheels 104 mounted to them, such that the robot constructed on chassis 100 can move about a space. In addition, in the illustrated embodiment, two motors (not shown) are mounted to chassis 100. In the illustrated embodiment, each motor drives one of the wheels in response to one or more signals received from a component attached to the chassis (not shown).

The illustrated embodiment also shows a portion 106 usable to sense a condition of the surface under the chassis 100. For example, the portion 106 may include one or more sensors configured to sense whether the disclosed chassis is positioned over or near a white line drawn on a dark background. Chassis 100 also includes arms 108. In various embodiments, arms 108 may be used to mount various components to the chassis 100. For example, arms 108 may be configured to have one or more pressure sensors mounted thereto, enabling the disclosed chassis to implement a robot configured to detect collisions with a wall or other object. In another embodiment, arms 108 may support a movable component of the disclosed robotic system, such as a shovel or broom, depending upon the desired functionality for the disclosed robotics system.

In various embodiments, discussed in detail below, one or more components is connectable to the chassis 100 via connection points 110. For example, one or more uprights may be connected to the chassis 100 by inserting a portion of the upright through the connection point 110 and tightening a machine screw or thumb screw to the upright.

In various embodiments, the chassis has a different shape, different number of mount points for wheels or other mobility components, and/or different numbers of breadboards mounted on or connected to it. In other embodiments, the chassis is formed of a polymer and is not formed by folding a planar sheet of material, such as metal. In these embodiments, the chassis is adapted to one or more contemplated types of robots. For example, in one embodiment in which the disclosed robotic system is configured to float in water or another liquid, the chassis may have a shape resembling the hull of a boat. In the illustrated embodiment, the chassis is adapted to a robot designed to move on the wheels 104, but in other embodiments the chassis 100 is adapted to have other propulsion devices, such as propellers or paddle wheels, to move in other environments and on other surfaces.

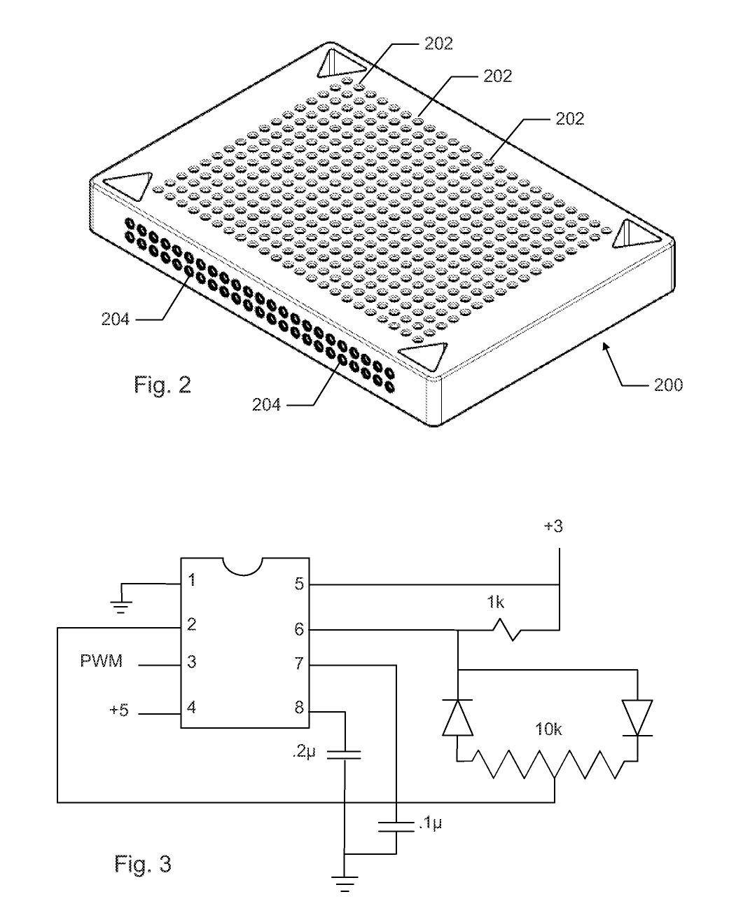

FIG. 2 illustrates a perspective view of a schematic diagram of one embodiment of a breadboard usable with the robotics system disclosed herein. Specifically, FIG. 2 illustrates a breadboard 200 that is attachable to a chassis, such as chassis 100 of FIG. 1. In the illustrated embodiment, breadboard 200 includes a plurality of connection points 202. In one embodiment, each connection point 202 is a hole or other opening in the breadboard 200 into which one or more conductors can be plugged. For example, connection points 202 may be holes having conductive materials disposed around their inner perimeters. The conductive materials may be disposed with an appropriate diameter so that conductors such as jumpers or other wires can be plugged into connection points 202 of the breadboard 200. In one embodiment, plugging a wire or jumper into a certain connection point 202 causes an electrical connection to be made between the connected wire and each other connection point 202a the same row or same column as the utilized connection point.

In a further embodiment, breadboard 200 of FIG. 2 includes a plurality of edge connection points 204 mounted on a narrow side, or edge, of breadboard 200. In this embodiment, edge connection points 204 enable connections to be made between a plurality of breadboards or to one or more other connection points 202 or 204 of the illustrated breadboard 200. It should be appreciated that the use of edge connection points 204 on a narrow side or edge of breadboard 200 may advantageously enable connections to be made among and/or between a plurality of breadboards stacked on a chassis 100 as further discussed in detail below. That is, connections between laterally stacked breadboards may be made by connecting jumpers or wires between edge connection points 204 of the respective stacked breadboards, rather than the relatively cumbersome need to connect a connection point 202 on the large face of a first breadboard 200 to a connection point 202 on the large face of a second, stacked breadboard 200.

In various embodiments, the disclosed robotics system is constructed using a chassis and one or more breadboards, such as disclosed and discussed with respect to FIGS. 1 and 2. In these embodiments, the use of a generic chassis and one or more generic breadboards enables the connection of various input and/or output devices to implement a robot capable of a desired set of functionality. In other embodiments, breadboards are not used, and instead one or more other logical electronic components, such as Printed Circuit Boards (PCBs) are used in their place.

In various embodiments, the robotics system disclosed herein is usable to perform various tasks and/or to operate according to certain logical constraints. For example, the disclosed robotics system may be movable by motor-driven tank treads or motor-driven wheels (if the robot is designed for use on a solid surface, may be movable by paddle wheels or a submerged propeller (if the robot is designed to float in water or some other fluid), or may be movable by propellers or jets (if the robot is designed to fly through the air). In such embodiments, these output components are affixed or attached to a chassis in a similar fashion to that described above. In addition, the disclosed robotics system could rely on varying kinds of sensors to detect conditions of its environment. For example, the system could rely on optical sensors, infrared sensors, aural sensors, motion sensors, proximity sensors, motion sensors, gyroscopic sensors, or any other appropriate type of sensor depending on the desired functionality of the disclosed robotics system.

One example project, which is a robotics system based on the chassis/breadboard system discussed above with respect to FIGS. 1 and 2, is illustrated in FIGS. 3, 4, 5, and 6, and is described in more detail below. The illustrated example project is a combinatorial logic line follower that relies on optical sensors mounted to a chassis to sense whether the robot is following a line printed or otherwise disposed on the surface under the robot. The example project also includes logic and output devices (i.e., a pair of motors) to drive a pair of wheels such that the robot will re-acquire and follow a line in the event it veers off course. In the example project, the components are connected to one another using wires or jumpers, such that electrical signals indicative of what the sensors sense can be converted into signals to drive the wheels as appropriate.

Specifically, the exemplary combinational logic line follower robot disclosed herein is a modularly designed robot that includes a plurality of sensors and output devices to cause the robot to follow a white line disposed on a black background. The disclosed robotics system includes a sensor module that in one embodiment has been optimized for minimal component use and robust tracking, including a right-hand circular search pattern. The illustrated embodiment also includes a pulse-width modulator to enable variable speed settings. In an embodiment, use of the pulse-width modulator may help to eliminate line overshoot problems on the fly. FIG. 3 illustrates exemplary circuitry for implementing the disclosed pulse width modulator, wherein well-understood symbols for conventional circuit elements (such as resistors, capacitors, and the like) are used to represent those conventional circuit elements.

In the embodiment illustrated in FIGS. 3, 4, 5, and 6, the disclosed robotics system includes a control logic scheme created based on a combination of reasoning and Karnaugh map simplification. In the illustrated embodiment, the control logic scheme is determinable based on the assumption that the disclosed robotics system relies on three adjacent sensors across the front of the chassis, each of which is capable of detecting the presence of a white line and outputting a signal indicative of the detected white line.

In addition, the illustrated embodiment of the disclosed robotics system relies on two motors and two wheels, wherein each motor separately drives one of the wheels. Thus, in the illustrated embodiment, driving a right motor drives a right wheel, driving a left motor drives a left wheel, and driving both motors drives both wheels. It should thus be appreciated that by driving the right motor in one embodiment, the robot turns to the left (i.e., because only the right wheel is turning), by driving the left wheel the robot turns to the right, and by driving both wheels the robot moves in a straight line.

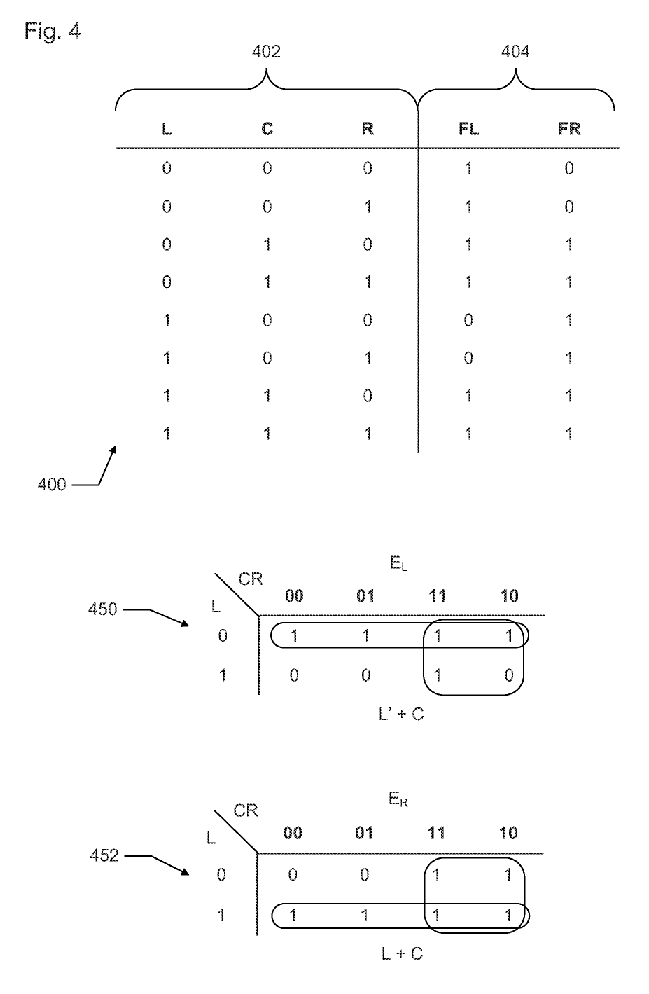

FIG. 4 illustrates an example truth table 400 illustrating the logic associated with the three-sensor, two-motor design illustrated herein. The left portion 402 of the truth table contains a set of all the possible combinations of the states of the three sensors. The L column indicates the state of the left sensor, where a “0” means the sensor does not detect a line, and a “1” indicates the sensor does detect a line. The C column indicates the state of the center sensor, and the R column indicates the state of the right sensor. For each row of the illustrated truth table, the columns FL and FR indicate whether to drive the left motor, the right motor, or both motors.

In the illustrated embodiment, the control logic determines if only the right or left sensor detects the presence of the white line. In such embodiments, the control logic causes the opposite motor from the determined sensor to be turned on, and further causes the motor on the same side of the sensor to be stopped. In this condition, the opposite wheel drives the robot in such a way as to put the robot back on course.

For example, in the fifth row of the table 400 of FIG. 4, a condition is illustrated in which the left sensor detects the presence of a line, and neither the right nor the center sensors detect the presence of the line. Thus, according to the truth table, the right motor will be driven until the robot has corrected its course, such that the center sensor again detects the presence of a line. In the illustrated truth table, if the right sensor detects the presence of the line and neither other sensor detects the same presence, the right motor is driven until the robot has corrected its course, such that the center sensor again detects the presence of a line. It should be appreciated that in the illustrated truth table, whenever the center sensor detects the presence of the line, both wheels are driven, as the robotics system assumes it is correctly aligned with the line.

In addition, in the first row of the table 400 of FIG. 4, it should be appreciated that none of the left, center, or right sensors detect the presence of a line. In this situation, the disclosed robotics system arbitrarily determines to drive the left motor, turning the robot to the right, until the line is acquired. In another case, illustrated in the sixth row of the table 400, the left and right sensors detect the presence of the line, but the center sensor does not. In this embodiment, the disclosed robotics system arbitrarily elects to drive the right motor, turning the robot left, until the line is reacquired. In this embodiment, the selection to turn the robot to the left is arbitrary, and serves to cause the center sensor to again reacquire detection of the white line. It should be appreciated that these so-called outliner cases are exemplary, and depend on the sensor/locomotion configuration of the disclosed robotics system.

Referring to the Karnaugh maps 450 and 452 of FIG. 4, the disclosed system enables the simplification of logic using such exemplary Karnaugh maps. Simplifying the logic for left and right motor enable signals, illustrated in table 400, reveals that the right sensor is unnecessary, and that the calculation for both signals would require nothing more than a pair of OR gates and an inverter. This conclusion, which enables the simplification of the disclosed robotics system, might also be reach by reasoning—if the center sensor is on the line, the robot should progress forward. If the left sensor detects the line but the center and right sensors do not, a turn to the left will center the robot back on the line. If the right sensor is on the line without the other sensors, a right-hand turn makes sense. If the robot does not receive any high inputs from its sensors, it could be made to spin to the right. When taken together, these last two actions support the assumption that if there is no sensor input on the left or center sensors, the line can be found to the right side of the robot. This eliminates the need for a right side sensor, since the absence of a signal from the other two sensors imply that the left motor should be enabled.

The illustrated Karnaugh maps 450 and 452 indicate the idea that the disclosed robotics system enables the simplification of logic (and components) by a relatively more advanced user. That is, a relatively novice user could implement the illustrated robotics design using three sensors, but performing additional logical analysis (i.e., Karnaugh map simplification) reveals that the same design can be implemented with fewer sensing components. Thus, the system advantageously enables users to implement the same designs in different ways depending on the sophistication of the users.

In the illustrated embodiment, one important consideration is the handling of what is known as “overshoot error.” Specifically, overshoot error may occur if the robot is made to turn too quickly, and therefore corrects its path too far in the direction of turning. For example, if the disclosed system drives the motors to cause the robot to turn to the right too quickly, the left sensor may not trigger a left turn in time to prevent the robot from jumping the line. In this situation, the robot may make a 180-degree turn before finding the line again and proceed opposite from its original direction of travel. This risk may be minimized in one embodiment by reducing the motor speed driving the wheel or wheels that cause the robot to turn. For example, the illustrated robotics project may rely on one or more pulse-width modulator duty cycles to slow the motor speed driving the robot's wheels. In this embodiment, the risk of “overshoot error” can be reduced and/or eliminated.

In another case, in which the robot leaves the white line entirely, the disclosed tables in FIG. 4 illustrated that the robot will continue to spin in a clockwise circular path until it is physically placed on the path. In other embodiments, the disclosed system may cause the robot to turn slightly, and proceed in a straight line, in a predetermined pattern until the robot re-acquires the white line it is designed to follow.

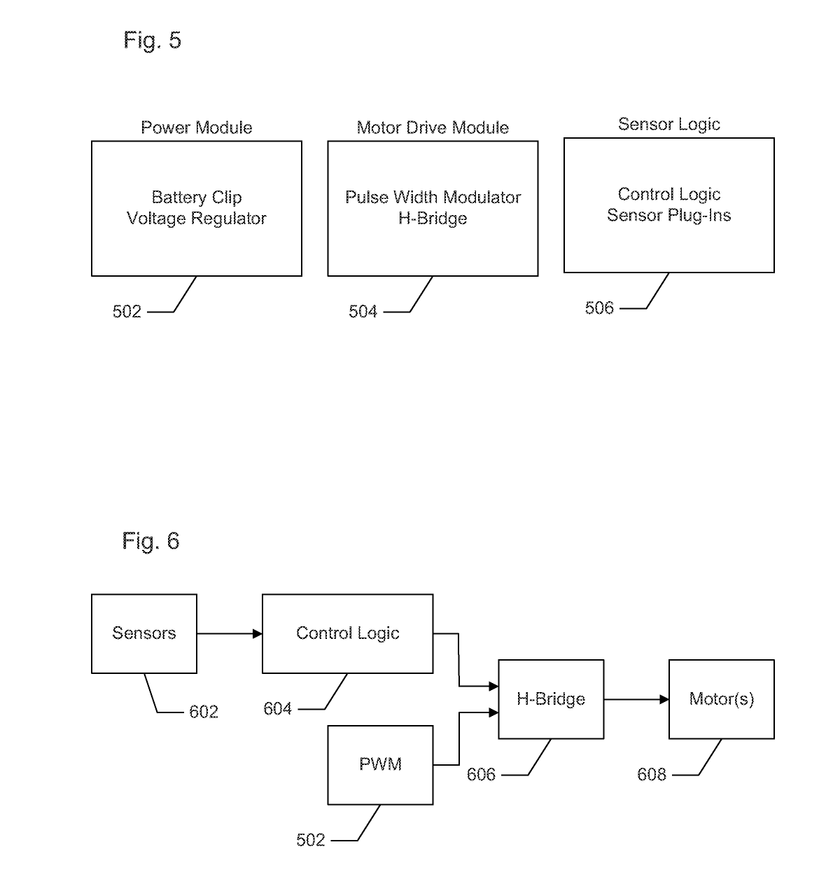

FIG. 5 illustrates a simplified block diagram of the modules used in one embodiment of the combinatorial line-following implementation of the disclosed robotics system. In FIG. 5, three different modules are disclosed—a power module 502, a motor drive module 504, and a sensor/logic module 506. In the illustrated line-following embodiment, the power module 502 and the motor drive module 504 form the base of the robot and are used regardless of the sensors or signal control schemes used in the sensor/logic module 506. In this embodiment, the purpose of the power module is to provide housing for the batteries and a 5 Volt regulator for the TTL level components. Further, in this embodiment, the motor drive module contains a duty cycle adjustable pulse width modulator (or PWM), which feeds into the enable pin of an H-bridge. By adjusting the PWM potentiometer, the motors can be made to run faster or slower when turned on. The H-bridge itself receives the motor enable signals from the sensor/logic module in response to the sensor status and switches the motors between running and stopping modes. Finally, the sensor/logic module 506 in the illustrated embodiment provides terminals for the sensors to plug into and the ability to process these inputs to determine the desired motor operation.

In various embodiments, the sensor/logic module 506 sits atop the motor module 502 and may be swapped with a different circuit card for another application while maintaining the use of the other components. For example, future students may wish to adapt the robot for a light-follower by replacing the black/white sensing line follower card with a card that uses photodiodes and a microprocessor. In this embodiment, the sensor/logic module 506 (or a portion thereof) may be replaced to enable the installation of a component capable of understanding outputs of one or more photodiodes, such that the motors can be driven according to those outputs. In one embodiment, small tabs (such as the arms 108 of FIG. 1) stick out from the chassis at angles to allow switches to be mounted for an edge avoiding robot project.

FIG. 6 illustrates an example of a simplified block diagram of the robotics system disclosed herein. In the illustrated embodiment, the robotics system relies on sensors 602 connected to control logic 604 to determine how to use environmental information sensed by the sensors to control the robot. In the illustrated embodiment, an H-bridge 606 is relied on to control the speed of motors 608. In the illustrated embodiment, Pulse Width Modulator 610 serves as another input to the H-Bridge 606 to ensure that the motors do not turn so fast as to overshoot the line for which the sensors 602 are sensing. In various other embodiments, in which the disclosed robotics system is used to implement some other type of project (i.e., a project other than a line-following robot), the order of the illustrated blocks may be altered, and/or additional blocks or components may be relied on, depending on the desired functionality.

As noted above, the illustrated combinatorial line follower project is exemplary and illustrates how the disclosed system can be used to connect a plurality of modules to create a functional, educational robotics project. It should be appreciated that the instant disclosure contemplates robots with other functionalities and controlled by other logical schemes. For example, various embodiments of the disclosed robotics system include a robotics project designed to float in water may be controlled according to calculated distances traveled in a given direction, and thus may include sensors to detect distance traveled and time. Other designs are also contemplated hereby.

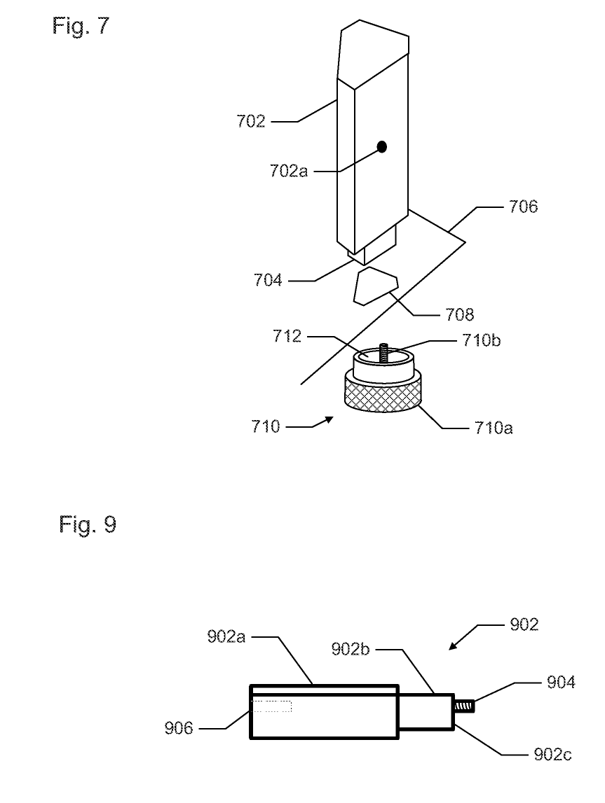

In various embodiments, the disclosed system relies on proprietary physical connectors to connect components to each other and/or to the disclosed chassis. One example of such proprietary connector technology is illustrated in FIG. 7.

Referring now to FIG. 7, an upright 702 is illustrated. In various embodiments, the upright 702 is connected to a component or sensor, and/or enables a component or sensor to be connected to, affixed to, or mounted on the upright 702. In the illustrated embodiment, the upright has a hexagonal cross-section, with three of the six sides being relatively shorter than the other three. Thus, the disclosed upright has a hexagonal cross-section with an approximately triangular shape. This shape may, in various embodiments, be described as a truncated equilateral triangle, or as having triangular prism geometry.

In various embodiments, the disclosed uprights 702 are available in many different lengths. In one embodiment, the uprights 702 have holes, such as hole 702a of upright 702 of FIG. 7, at regular distances from an end that is mounted to the chassis to the top end of the upright. These holes are configured and sized to accept a metal shaft with a textured screw head on one end and threading on the other end, as will be discussed in more detail below.

In the illustrated embodiment, the upright also includes a stem portion 704. In this embodiment, the stem portion 704 also has a hexagonal cross-section; however it is reduced in size such that it is similar to but smaller than the hexagonal cross-section of the upright 702. In an embodiment, the stem portion 704 includes a threaded hole (not visible in FIG. 7), such that one or more threaded studs can be threaded into the hole.

In an embodiment, the chassis 706 (or another component of the disclosed system, such as breadboard) includes an aperture 708 having the same size and shape as the stem portion 704 of the upright 702. In the illustrated embodiment, the stem 704 is insertable in the aperture 708 such that the upright can be securely fastened to the chassis 706. The aperture 708 may be sized such that the stem portion 704 fits snugly in the aperture 708. In the illustrated embodiment, the aperture 708 prevents lateral movement of the upright 702 with respect to the chassis 706, but does not prevent movement in the axial direction.

In the illustrated embodiment, thumbscrew 710 includes a grip portion 710a and a stud portion 710b. The thumbscrew 710 may have a wide, thick head with a textured grip, such that no special tools are needed to tighten them down. The stud portion 710b is inserted in a cavity 712 sized such that the shape of the stem 704 its within the cavity 712. Further, in the illustrated embodiment, the cavity 712 has a diameter such that the entire thumbscrew 710 can be rotated about the stem portion 704. In the illustrated embodiment, the thumbscrew 710 can be tightened, threading the stud 710b into the hole of the stem 704 of the upright 702, until the thumbscrew 710 is adjacent to the chassis 706, thus securing the upright against movement in the axial direction. It should be appreciated that in this embodiment, the cavity 712 is deep enough to receive the full length of the stem 702 when the thumbscrew 710 is threaded into the hole of the stem of the upright.

In one embodiment, each upright usable with the disclosed system includes a stem with a same shape, such as the hexagonal shape illustrated in FIG. 7. In this embodiment, each stem can be inserted in each hole, and a thumbscrew tightened around the stem. In another embodiment, uprights and/or other components are provided with stem portions having different shapes, such that only certain components can be fastened to certain holes in certain other components. In various embodiments, the use of different shaped stems restricts a user from inserting components or uprights in places they should not go according to a designated design of the disclosed robotics system. For example, a stem usable to affix a wheel to the chassis may prevent the wheel from being inserted in the top of the chassis, and may instead restrict the wheel to insertion in an appropriate side-portion of the chassis.

In one embodiment, each of any shapes of stems used by components/uprights of the disclosed system has a same maximum diameter. In this embodiment, any thumbscrew having an appropriate diameter can accommodate any stem, while the shape of apertures in the chassis or other components defines which stems can be inserted in which components. Thus, while components or uprights may be limited in their use, thumbscrews can be used with any component, upright, or aperture.

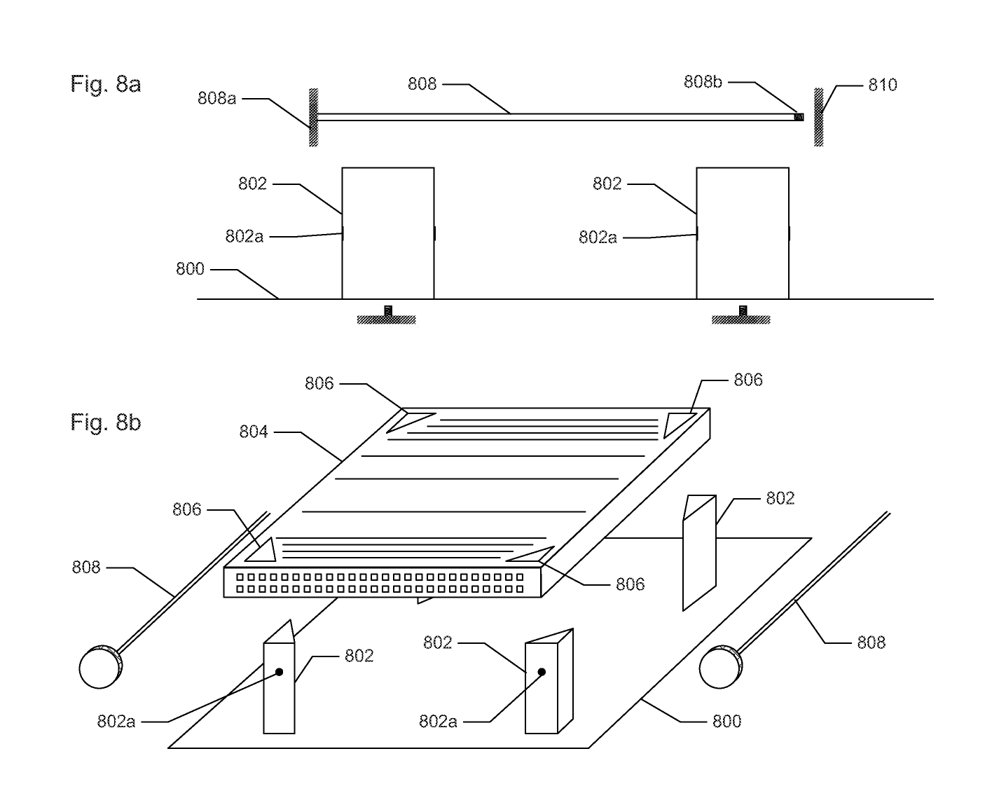

FIGS. 8a and 8b illustrate an example application of the disclosed uprights 802 used in conjunction with a chassis 800 to enable breadboard to 804 be installed on the chassis 800. It should be appreciated that FIG. 8a is a side view of the disclosed use of uprights 802, while FIG. 8b is a perspective view of the same use. In the illustrated embodiment, breadboard 804 includes a plurality of openings 806 that are sized and shaped to fit the cross-section of the uprights 802. In the embodiment illustrated in FIGS. 8a and 8b, each upright 802 includes a hole 802a that enables a shaft 808 to be inserted therethrough. Shaft 808 includes a thumbscrew 808a at one end, such that shaft 808 can be easily rotated by a user installing the shaft 808 through the holes 802a of the uprights 802. At its other end, shaft 808 includes a threaded portion 808b. Threaded portion 808b enables a thumbscrew or rotating end cap 810 to be threaded onto the shaft 808. Thus, the disclosed system enables a user to insert shaft 808 through the holes 802a of the uprights 802, and further enables the rotating end cap 810 to be tightened to the shaft 808 such that the shaft is fastened in place.

In the embodiment illustrated in FIGS. 8a and 8b, when the shaft 808 is inserted through the holes 802a in the uprights 802 and rotating end cap 810 is tightened onto the threaded end 808b of the shaft 804, the shaft forms a standoff onto which a breadboard 804 can be lowered. Specifically, the breadboard 804 is lowered onto uprights such that the openings 806 fit over the uprights 802 and such that the breadboard comes to rest on shafts 808.

In the illustrated embodiment, by creating one standoff on either side of the chassis and lowering a breadboard onto it, then building another set of standoffs above the installed breadboard on the same uprights and lowering another breadboard on top, the disclosed system enables the creation of a two-layered design which is implemented on top of the chassis. In one embodiment, in which a two-layered breadboard design is implemented, in order to ease making electrical connections from one breadboard to the other, the breadboards include two rows of contact points on their edge faces in addition to the contact that are found on top of a typical breadboard, as was discussed with respect to FIG. 2.

FIG. 9 illustrates an alternative embodiment of the uprights disclosed herein. Specifically, FIG. 9 illustrates uprights 902, which are usable in various embodiments to install components such as breadboards onto a chassis of the disclosed robotics system. In the illustrated embodiment, uprights 902 include a body portion 902a and a component installation portion 902b. The component installation portion in the illustrated embodiment has a same, triangular cross-section as the body portion 902a, but has reduced dimensions. In the illustrated embodiment, corresponding openings in components to be installed on the chassis match the shape and size of the component installation portion 902b, such that the component can be installed by nesting the component installation portion 902b in the component. In the illustrated embodiment, the component installation portion 902b has a length approximately equal to a thickness of a component, such that when the component is installed on the upright 902, the end 902c of the component installation portion 902b is approximately flush with a surface of the component.

In the illustrated embodiment, the upright 902 also includes a threaded portion 904. Threaded portion 904 is configured to have either another upright 902 threaded onto it, such as through female threaded portion 906, or to have a thumb-screw or other fastener affixed. In various embodiments, threading another upright 902 or other fastener on the threaded portion 904 prevents an installed component from being moving in the longitudinal direction of the upright 902. Thus, the disclosed uprights enable uprights to be stacked upon one another, with components (such as breadboards) installed on the component installation portion 902b, and with the other uprights preventing removal of the components.

In one embodiment, the disclosed upright mounted to the chassis is fastened to the chassis by inserting a machine screw with a flat head through a hole in the chassis and into female threaded portion 906, such that the upright 902 is affixed to the chassis. It should be appreciated that any suitable method of affixing the uprights to the chassis may be used, including permanently affixing a first layer of uprights to the chassis using welding techniques, adhesive, rivets, or other suitable fastening techniques.

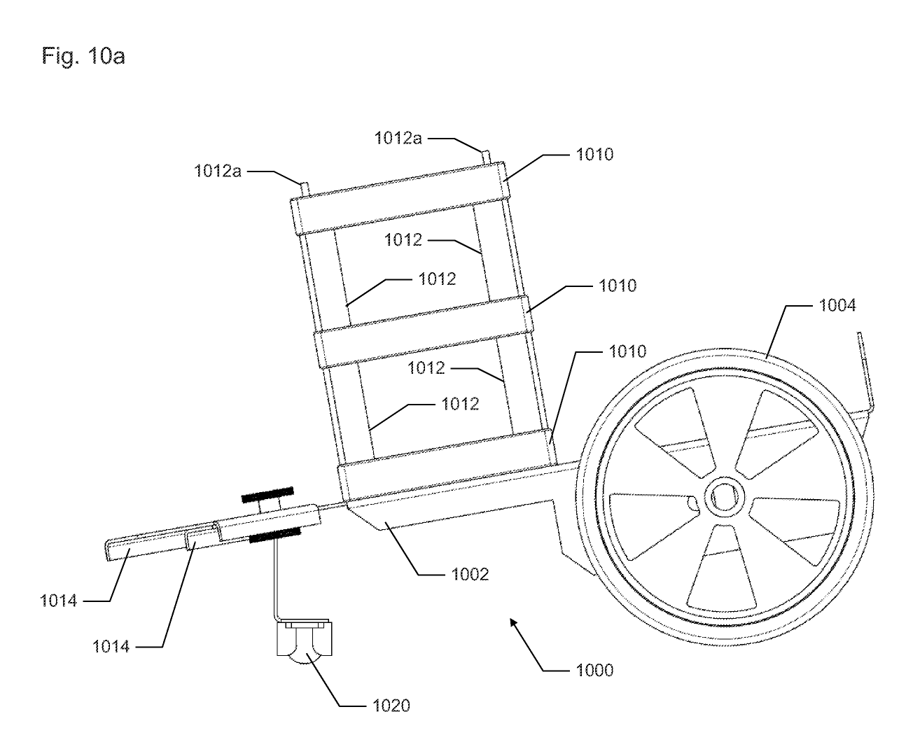

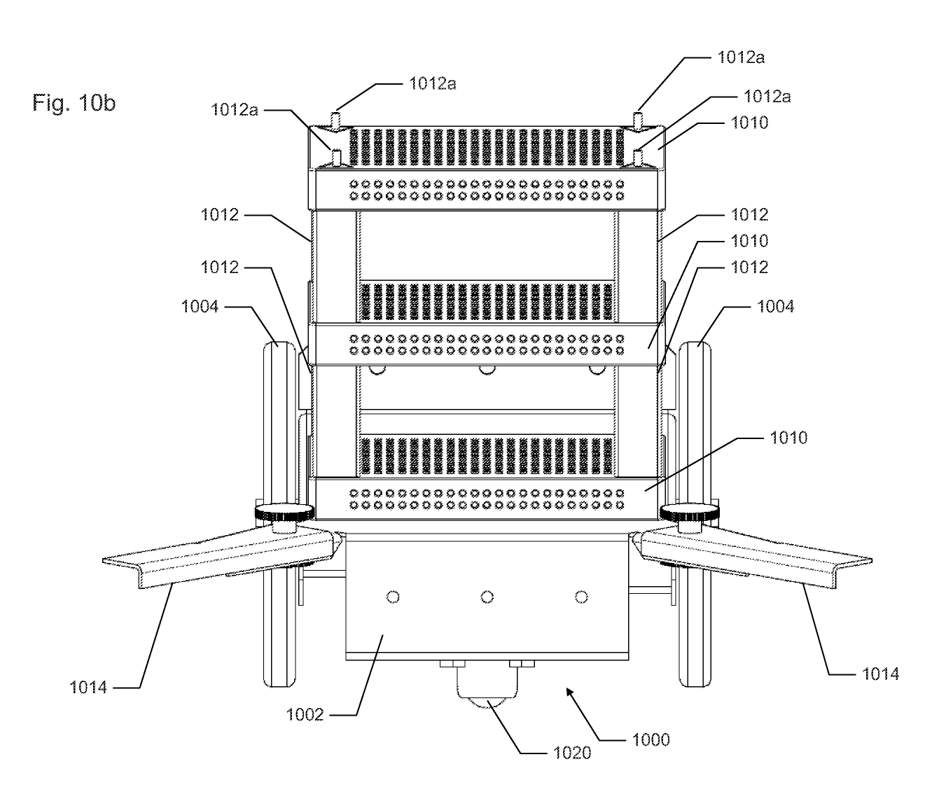

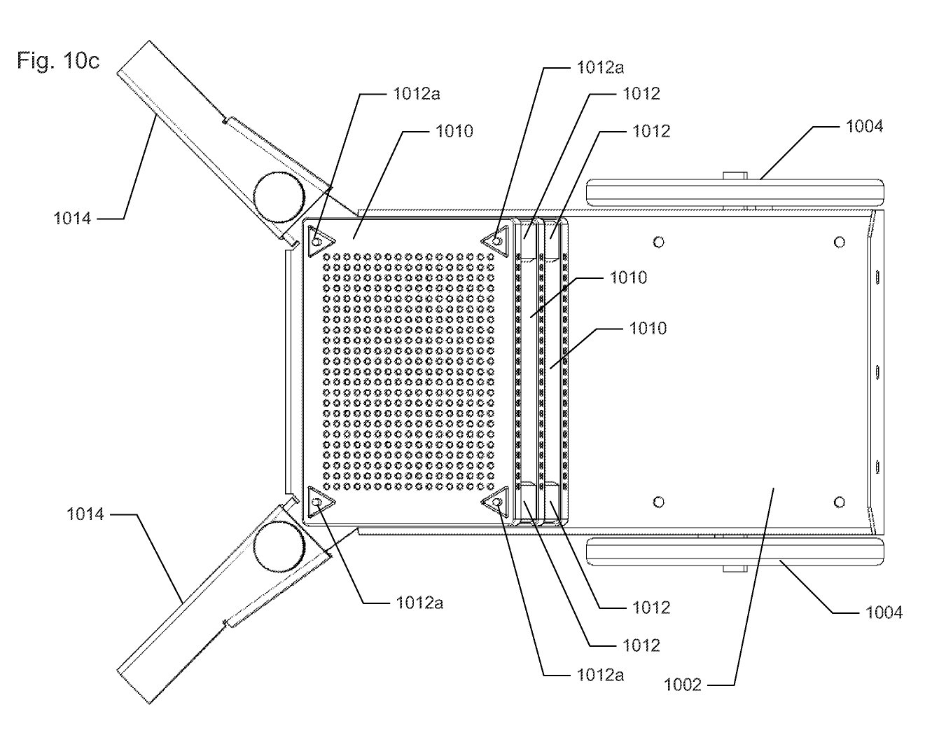

FIGS. 10a, 10b, and 10c illustrated schematic diagrams of a completed robot 1000, such as the combinatorial line following robot described in detail above. Specifically, FIG. 10a illustrates a side perspective view of the disclosed robot 1000, FIG. 10b illustrates a front perspective view of the disclosed robot 1000, and FIG. 10c illustrates an overhead perspective view of robot 1000. It should be appreciated that in the illustrated embodiment, the wires and/or logical elements required are not illustrated for clarity.

In the embodiment illustrated in FIGS. 10a, 10b, and 10c, robot 1000 includes a chassis 1002, a plurality of wheels 1004, one or more motors (not shown), a battery (not shown), and a plurality of breadboards 1010. In the illustrated embodiment, the disclosed robotics system 1000 also includes a roller 1020 mounted on the front of the chassis to enable the disclosed robotics system to easily move and pivot depending on the direction and amount of power applied to the wheels 1004 by the motors mounted under the chassis 1002. In various embodiments, the roller 1020 enables the portion of the chassis 1002 above the roller 1020 to move in any desired direction, such as straight forward, straight backward, or in a circle.

In the illustrated embodiment, breadboards 1010 are mounted to chassis 1002 using uprights 1012, and in the illustrated embodiment two layers of uprights 1012 enable the stacking of three breadboards 1010. In the illustrated embodiment, the uprights 1012 have a triangular cross-section, as is most clearly seen in FIG. 10c. Moreover, each upright 1012 includes a female threaded portion (not shown) and a male threaded portion 1012a which enables the upright to be threaded into another upright or into a thumb screw, machine screw, or other terminating device.

Robot 1000 of FIGS. 10a, 10b, and 10c further includes arms 1014 that may include pressure sensors or other sensors to enable the robot to determine when it has struck or come into contact with an object, such as a wall. In such an embodiment, the robot 1000 may determine whether either or both of the arms 1014 have come into contact with an object, and may take appropriate corrective action to steer away from the contacted object. In some embodiments, arms 1014 enable the mounting and/or connection of other components, such as a shovel or other component, to the front of the robot 1000.

It should be appreciated that other configurations of the disclosed robot, beyond those illustrated in FIGS. 10a, 10b, and 10c, may also be appropriate as desired by the implementer and/or as required by the task or tasks to be performed by the robot 1000.

In other embodiments of the disclosed robotics system, additional functional output components may be affixed to the chassis to achieve various design goals. For example, in one embodiment, a bulldozer or lift attachment can be attached to the front of the disclosed chassis to perform pushing or lifting tasks. In another embodiment, a crane or shovel arm that attaches may be attachable to the chassis via one or more uprights and/or standoffs. In other embodiments, a tank turret may attach on top of the standoffs (i.e., a component that turns on two axes and fires marbles or plastic pellets), a brush may attach to the front for a sweeping robot, and/or a flipper may attach to the front for kicking a ball (for robot soccer competitions).

In various embodiments other than the combinatorial line following robot embodiment disclosed above, additional sensors may be connected to enable the disclosed system to detect other characteristics of its environment. For example, black/white sensors, light sensors (photodiodes), microphones, RF receivers, and/or pressure switches may be connected to the disclosed chassis. In other embodiments, robotics projects may take advantage of accelerometers, electronic compasses, GPS receivers, cameras, infrared/heat sensors, or sonic rangefinders. For instance, a robotics project simulating an aircraft flight management system may rely on a combination of accelerometers, electronic compasses, and GPS receivers.

As discussed above, the system disclosed herein enables users to build robots of varying complexity by simply adding or removing electronic components and breadboards and connecting them in a desired configuration. The chassis, which may be a single piece of folded metal or some other appropriate substrate, may include mount points for mechanical additions, such as battery casings, motors, switches, potentiometers, lever arms, tires, ball casters and treads. These mechanical pieces may be traded in or out depending on the needs of a particular activity. Proprietary mechanical fasteners can be used for stacking the breadboards and attaching expansion pieces to the chassis. In addition, one or more components designed for younger, less dexterous individuals may be electronically keyed such that upon making an electronically acceptable connection, a light illuminates indicating an allowable connection has been made.

Because the system is designed to appeal to a wide range of ages and skill levels, various adaptations may be used depending on the age of the contemplated audience. For example, in addition to the breadboard prototyping approach described in detail above, the disclosed system may be operable with printed circuit boards to teach fundamental skills such as soldering and electromagnetic interference reduction techniques. These printed circuit boards (or PCBs) may fit in the same mechanical footprint as the breadboards disclosed and discussed above. Thus, as with the breadboards, the PCBs may be stacked and used in conjunction with functional blocks that are built onto breadboards, sensors, or other components. Additional components may enable the teaching and study of additional engineering topics, including embedded microprocessor programming, FPGA logic design, wireless communications, cluster computing, artificial intelligence, and autonomous systems.

It should be understood that modifications and variations may be effected without departing from the scope of the novel concepts of the present disclosure, and it should be understood that this application is to be limited only by the scope of the appended claims.

The invention is claimed as follows:

1. An apparatus for modular construction of a robotic device, said apparatus comprising:
a chassis including a plurality of breadboard receiving portions and a plurality of physical interface receiving portions, wherein:
(a) each of the plurality of breadboard receiving portions is configured to receive a breadboard implementing a portion of logic by which said robotic device operates,
(b) each of the plurality of physical interface receiving portions is configured to receive an input/output device for enabling the robotic device to sense its environment or to operate in response to its environment; and
a plurality of expansion modules configured to be connected to at least one of the plurality of breadboard receiving portions or at least one of the plurality of physical interface receiving portions.

2. The apparatus of claim 1, wherein the input/output device is a sensor for sensing a condition of an environment of the robotic device.

3. The apparatus of claim 2, wherein the sensor includes one selected from the group consisting of a proximity sensor, a motion sensor, an optical sensor, and a directional sensor.

4. The apparatus of claim 2, which includes at least one motor connected to at least one ambulation component, said at least one ambulation component configured to move the robotic device within its environment.

5. The apparatus of claim 4, wherein the at least one ambulation component includes at least one selected from the group consisting of a wheel, a tread, a propeller, and a jet engine.

6. The apparatus of claim 1, which includes at least one connector component for mechanically connecting the at least one expansion module to the chassis.

7. The apparatus of claim 6, wherein the at least one connector component includes at least one stem portion insertable in at least one aperture of the chassis.

8. The apparatus of claim 7, wherein the at least one stem portion includes a threaded hole, and which includes at least one thumbscrew configured to encircle the stem portion when threaded into the threaded hole.

9. The apparatus of claim 7, which includes a plurality of connector components each having a stem portion with a different cross-sectional shape, the stem portion of a first of the connector components insertable in a first aperture in the chassis but not in a second aperture, and the stem portion of a second of the connector components insertable in a second aperture in the chassis but not in a first aperture.

10. The apparatus of claim 1, wherein the plurality of expansion modules each includes logic to cause the robotic device to operate according to at least one signal received from the input/output device.

11. The apparatus of claim 1, wherein one of the plurality of expansion modules is a printed circuit board.

12. The apparatus of claim 1, wherein one of the plurality of expansion modules is a programmable module which can be programmed by a user of the robotic device.

13. The apparatus of claim 1, which includes at least one wire component configured to indicate a correctness of connection when said at least one wire is connected to the breadboard.

14. The apparatus of claim 13, wherein the wire component includes at least one light emitting portion to emit a light indicating the correctness of connection.

15. An upright connectable to a chassis of a robotic device, said upright comprising:
a body including:
at least one exterior shape,
at least one stem portion including a threaded hole and having a stem shape similar to but smaller than the exterior shape, said stem portion insertable in an aperture of the chassis of the robotic device such that said stem portion extends beyond the chassis; and
a round thumbscrew having a graspable portion, a threaded post, and a cavity having a diameter equal to a diameter of the stem portion such that the thumbscrew is threadable on the at least one stem portion regardless of a shape of the at least one thread portion.

16. The upright of claim 15, wherein the body includes at least one hole into which at least one support bar is insertable such that the at least one support bar can support at least one component of the robotic device.

17. The upright of claim 16, wherein the at least one component of the robotic device includes at least one selected from the group consisting of a breadboard, a printed circuit board, a sensor, and an output device.

18. The upright of claim 15, wherein the stem shape is insertable into some but not all apertures in the chassis of the robotic device.

19. The upright of claim 15, wherein, when tightened onto the stem, the cavity of the round thumbscrew envelopes substantially all of the stem portion of the body.

20. The upright of claim 15, which enables the stacking of components into a multi-tier component stack.
